(19) United States
(12) Patent Application Publication
(10) Pub. No.: US 2021/0277257 A1
(43) Pub. Date: Sep. 9, 2021

(54) Paint system with anti-fouling character

(71) Applicant: Evonik Operations GmbH, Essen (DE)

(72) Inventors: Katrin ROLAND, Essen (DE); Julia Foth, Rheinberg (DE); Günther Michael, Karlstein (DE); Dennis Schleifnig, Olfen (DE)

(73) Assignee: Evonik Operations GmbH, Essen (DE)

(21) Appl. No.: 17/190,919

(22) Filed: Mar. 3, 2021

(30) Foreign Application Priority Data
Mar. 6, 2020 (EP) 20161345.2

(51) Int. Cl. C09D 5/16; C08K 3/36; C08K 3/08; C08K 3/22; C08K 3/26; C08K 3/30

(52) U.S. Cl. CPC C09D 5/1618; C08K 2003/3045; C08K 3/36; C08K 3/08; C08K 3/22; C08K 3/26; C08K 3/30; C08K 2201/006; C08K 2003/0806; C08K 2003/085; C08K 2003/0887; C08K 2003/2231; C08K 2003/2241; C08K 2003/2248; C08K 2003/2258; C08K 2003/2262; C08K 2003/2286; C08K 2003/2296; C08K 2003/265; C09D 5/1625

(57) ABSTRACT

A paint system contains an anti-fouling metal oxide and a fumed silica, wherein the fumed silica has a BET surface area of 150 to 400 m²/g, a tamped density of 100 to 300 g/l, and a thickening of less than 500 mPas, in which the percentage by weight of silica≤the percentage by weight of the metal and/or oxide thereof, based on the total weight of the paint system. The paint system also contains at least one water-binding organic and/or inorganic filler.

### CROSS-REFERENCE TO RELATED APPLICATIONS

This application claims priority to European patent application 20161345.2 filed Mar. 6, 2020, incorporated herein by reference.

### BACKGROUND OF THE INVENTION

### Field of the Invention

The invention relates to a paint system with anti-fouling character, based on at least one anti-fouling metal and/or oxide thereof and a fumed silica.

### Description of Related Art

Anti-fouling coatings which comprise metal oxides are known. The main problem associated with the use of metal oxides is their exponential release. This entails a high required fraction of metal oxides in the paint on the assumption of a biologically active biocide concentration over the lifetime of the coating.

U.S. Pat. No. 7,147,921 proposes solving the release problem by encasing copper with a film of silicon dioxide. What is observed is in fact that in spite of the film of silicon dioxide, the release of the copper is undesirably rapid.

WO2013/036746 discloses core-shell particles whose core comprises copper and whose shell consists of a porous layer of silicon dioxide. The shell is applied by wet-chemical means using a sodium silicate solution.

WO2014/187769 proposes core-shell particles whose shell consists essentially of particulate silicon dioxide having a thickness of 0.1 to 10 μm and whose core consists of an anti-fouling metal oxide with an average particle diameter of 1 to 20 μm. The bond of the shell to the core is a fixed bond. In the case of dispersion, no significant parting of this bond is observed. The core-shell particles can be produced by contacting a mixture of the core- and shell-forming materials with a specific energy input of 200 to 2000 kJ/kg. It is stated that, in the case of a specific energy input of less than 200 kJ/kg, a physical mixture of silicon dioxide particles and metal oxide particles is formed. It is stated that this mixture does not lead to reduced release of the anti-fouling material.

EP 3271426 describes an alternative to the paint systems containing core-shell particles that are known in the art, but these paint systems additionally do not have good paint properties, for example hardness, brittleness or storage stability.

### SUMMARY OF THE INVENTION

It is therefore desirable to provide an improved paint system having good anti-fouling character, but without the disadvantages of the paint properties known from the art.

It has now been found that, surprisingly, in accordance with the teaching of EP 3271426, it is possible to reduce the amount of fumed silicas used in order nevertheless to achieve excellent anti-fouling character. More particularly, it has additionally been found that the coatings produced with the paint system according to the invention have better storage stability, lower brittleness and higher hardness.

The present invention also includes the following embodiments:
1. Paint system based on at least one anti-fouling metal and/or oxide thereof and a fumed silica, wherein the fumed silica has a BET surface area of 150 to 400 m²/g, determined to DIN ISO 99277,
   a tamped density of 100 to 300 g/l, determined to DIN EN ISO 787/11, and
   a thickening of less than 500 mPas at 25° C., measured as disclosed in the description,
   obtainable after grinding with a specific energy input of 200 to 2000 kJ/kg, preferably 500 to 1800 kJ/kg, most preferably 700 to 1500 kJ/kg, calculated according to

specific energy input=(P_{D}−P_{D,0})×t/m
with P_{D}=total power input,
P_{D,0}=no-load power,
t=energy input time,
m=mass of silica introduced, characterized in that the percentage by weight of silica≤the percentage by weight of the metal and/or oxide thereof based on the total weight of the paint system, and in that the paint system includes at least one water-binding organic and/or inorganic filler.
2. Paint system according to embodiment 1, characterized in that the percentage by weight of silica relative to metal and/or oxide thereof is from 1:1 to 1:10, preferably 1:1 to 1:8, more preferably 1:1 to 1:5, based on the total weight of the paint system.
3. Paint system according to either of the preceding embodiments, characterized in that the organic and/or inorganic filler is zinc oxide, gypsum, barium sulfate, sheet silicates such as talc, kaolin or mica, carbonates such as chalk or calcite, or titanium dioxide.
4. Paint system according to any of the preceding embodiments, characterized in that the anti-fouling metal is preferably selected from the group consisting of copper, manganese, silver, tungsten, vanadium and tin, and oxides thereof.
5. Paint system according to any of the preceding embodiments, characterized in that the proportion of anti-fouling metal and/or oxide thereof is 0.5% to 60% by weight, preferably 1% to 40% by weight, more preferably 5% to 30% by weight, based on the total weight of the paint system.
6. Paint system according to any of the preceding embodiments, characterized in that the proportion of fumed silica is 0.5% to 30% by weight, preferably 1% to 20% by weight, more preferably 2% to 15% by weight, based on the total weight of the paint system.
7. Paint system according to any of the preceding embodiments, characterized in that the fumed silicas are hydrophilic or hydrophobic silicas.
8. Paint system according to any of the preceding embodiments, characterized in that it comprises film-forming resins.
9. Substrate coated with the paint system according to embodiments 1 to 8.
10. Substrate according to embodiment 9, characterized in that it has a theoretical release rate of at least 10 μg/cm²/day to at most 30 μg/cm²/day, measured to ASTM D 6442.
11. Process for producing a paint system according to any of embodiments 1-9, characterized in that anti-fouling metals and/or oxides thereof and fumed silica having a BET surface area of 150 to 400 m²/g, determined to DIN ISO 99277, having a tamped density of 100 to 300 g/l, determined to DIN EN ISO 787/11, and having a thickening of less than 500 mPas at 25° C., measured as disclosed in the description, are stirred into a paint matrix to form electrostatic interactions between the anti-fouling metal oxide particles and the fumed silica.
12. Process according to embodiment 11, characterized in that the stirring into the paint matrix is preceded by grinding of the fumed silica with a specific energy input of 200 to 2000 kJ/kg, preferably 500 to 1800 kJ/kg, most preferably 700 to 1500 kJ/kg,
   calculated by

specific energy input=(P_{D}−P_{D,0})×t/m
with P_{D}=total power input,
P_{D,0}=no-load power,
t=energy input time,
m=mass of silica used.
13. Process according to embodiment 11 or 12, characterized in that the stirring-in of the silica and metals and/or oxides thereof is performed at a shear rate of 1000 rpm to 5500 rpm, preferably 3500-4000 rpm, for 5-180 minutes, preferably 15-60 minutes, more preferably 30-45 minutes, up to a temperature of 60° C. with or without glass beads.
14. Use of the paint system according to any of embodiments 1 to 9 for the coating of the aquatic region of a watersports boat, a commercial ship or a built structure immersed in water.
15. Use of a fumed silica, wherein the fumed silica has a BET surface area of 150 to 400 m²/g, determined to DIN ISO 99277,
   a tamped density of 100 to 300 g/l, determined to DIN EN ISO 787/11, and
   a thickening of less than 500 mPas at 25° C., measured according to the description at page 4 lines 2-14,
   obtainable after grinding with a specific energy input of 200 to 2000 kJ/kg, preferably 500 to 1800 kJ/kg, most preferably 700 to 1500 kJ/kg, calculated according to

specific energy input=(P_{D}−P_{D,0})×t/m
with P_{D}=total power input,
P_{D,0}=no-load power,
t=energy input time,
m=mass of silica used, for a paint system comprising at least one anti-fouling metal and/or oxide thereof, characterized in that the percentage by weight of silica≤the percentage by weight of the metal and/or oxide thereof based on the total weight of the paint system.

### DETAILED DESCRIPTION OF THE INVENTION

The invention provides a paint system comprising at least one anti-fouling metal and/or oxide thereof and a fumed silica having a BET surface area of 150 to 400 m²/g, determined to DIN ISO 99277, a tamped density of 100 to 300 g/l, determined to DIN EN ISO 787/11, and a thickening of less than 500 mPas at 25° C., measured as described below, obtainable after grinding with a specific energy input of 200 to 2000 kJ/kg, preferably 500 to 1800 kJ/kg, most preferably 700 to 1500 kJ/kg, calculated according to specific energy input=(P_{D}−P_{D,0})×t/m with P_{D}=total power input, P_{D,0}=no-load power, t=energy input time, m=mass of silica introduced, wherein the percentage by weight of silica≤the percentage by weight of the metal and/or oxide thereof based on the total weight of the paint system, and the paint system includes at least one water-binding organic and/or inorganic filler.

Fumed silicas are produced by flame hydrolysis of silicon compounds. In this process, a hydrolysable silicon compound is reacted in a flame formed by combustion of hydrogen and of an oxygen-containing gas. The combustion flame here provides water for the hydrolysis of the silicon halide, and sufficient heat for the hydrolysis reaction. This operation generally forms aggregates which form a three-dimensional network. A plurality of aggregates may form agglomerates. A fumed silica produced in this way is referred to as fumed or pyrogenic, hydrophilic silica. Silicas obtained directly from the flame process and having a BET surface area of 150 to 400 m²/g have a low tamped density and high thickening in paints. For instance, the tamped density is generally about 40 to 60 g/l and the thickening is more than 2500 mPas at 25° C. This fumed silica is unsuitable for the present invention.

The silica present in the present invention has a high tamped density combined with low thickening.

Preferably, the BET surface area is 180 to 330 m²/g, the tamped density is 150 to 250 g/l and the thickening is 250 to 400 mPas at 25° C.

The silica can be produced, for example, by grinding the above-described silica obtained directly from the flame process.

The fumed silica present in the paint system may also be a hydrophobized silica. It can be produced by reacting a hydrophilic silica as obtained from the flame process with a hydrophobizing agent and then grinding it. Useful hydrophobizing agents are mainly organosilanes, haloorganosilanes, silazanes or polysiloxanes. Preference is given to using dimethyldichlorosilane, octyltrimethoxysilane, octyltriethoxysilane, hexamethyldisilazane, hexadecyltrimethoxysilane, hexadecyltriethoxysilane and dimethylpolysiloxane. According to the hydrophobizing agent used and the amount thereof, there remains a carbon content of 1% to 10% by weight on the hydrophobized silica. This hydrophobized silica too is subsequently ground.

In both cases, hydrophilic and hydrophobic silica, grinding requires a specific energy input of 200 to 2000 kJ/kg, preferably 500 to 1800 kJ/kg, most preferably 700 to 1500 kJ/kg. The specific energy input is calculated as follows: Specific energy input=(P_{D}−P_{D,0})×t/m, with P_{D}=total power input. P_{D,0}=no-load power, t=energy input time, m=mass of silica used.

Energy input is at its optimum with an assembly having a power of at least 1 kW, preferably 151 to 20 kW, more preferably 2 to 10 kW. Preference is given to the use of a rotor ball mill. The grinding balls are preferably made of steel. When a rotor ball mill is used, P_{D} relates to the total power input, i.e. inclusive of silica and grinding balls. P_{D,0} describes the no-load power, i.e. without silica and grinding balls. The charging volume of the fumed silica in the rotor ball mill is preferably 10% to 80% by volume, preferably 20% to 50% by volume, based in each case on the volume of the rotor ball mill. The grinding time is preferably 0.1 to 120 minutes, more preferably 0.2 to 60 minutes, most preferably 0.5 to 10 minutes. In the course of grinding, it is possible to add up to 3% by weight of water, based on the amount of silica.

It has been found that this treatment step alters the aggregate structures and aggregate dimensions. The maximum aggregate diameter of such a ground silica is generally only 100 to 200 nm. Furthermore, the degree of branching and the number of primary particles per aggregate is reduced.

The BET surface area is determined in accordance with DIN ISO 99277 and the tamped density in accordance with DIN EN ISO 787/11.

The thickening, in mPas, is determined in a dispersion of the silicon dioxide powder in an unsaturated polyester resin, such as cocondensates of ortho- or meta-phthalic acid and maleic acid or fumaric acid, or the anhydrides thereof, and a low molecular weight diol, for example ethylene glycol, propane-1,2- or -1,3-diol, butane-1,2- or -1,3- or -1,4-diol, neopentyl glycol ((CH₃)₂C(CH₂OH)₂), or polyols such as pentaerythritol, preferably dissolved in an amount of 30% to 80% by weight, preferably 60% to 70% by weight, in an olefinic reactive diluent as solvent, for example monostyrene. The viscosity of the polyester resin is 1300+/−100 mPas at a temperature of 22° C. 7.5 g of silicon dioxide powder are introduced into 142.5 g of polyester resin at a temperature of 22° C. and dispersed therein with a dissolver at 3000 min⁻¹. 60 g of this dispersion are admixed with a further 90 g of the unsaturated polyester resin and dispersal is repeated. Thickening refers to the viscosity value in mPas of the dispersion at 25° C. measured with a rotary viscometer at a shear rate of 2.7 s⁻¹. An example of a useful unsaturated polyester resin is Ludopal® P6, BASF.

Preferably, the percentage by weight of silica relative to metal and/or oxide thereof is from 1:1 to 1:10, preferably 1:1 to 1:8, more preferably 1:1 to 1:5, based on the total weight of the paint system.

Astonishingly, a coating produced with the paint system of the invention has better anti-fouling action and improved paint properties, for example the hardness of the coating surface or brittleness, than a coating according to EP 3271426, even though less silica has been used relative to the anti-fouling metal and/or oxide thereof. The improved effects are set out in the examples, as described below.

Without being tied to any theory, these improved effects could result from the use of at least one water-binding organic and/or inorganic filler and the reduction in the amount of silica used. The water-binding organic and/or inorganic filler could serve here as a “pathway” in the coating in order to transport the anti-fouling metal and/or oxide thereof out of the coating and hence display its effect.

Preferably, the water-binding filler is zinc oxide, gypsum, barium sulfate, sheet silicates such as talc, kaolin or mica, carbonates such as chalk or calcite, or titanium dioxide.

It should be noted here that the zinc oxide in particular is not an approved biocide (i.e. an anti-fouling metal oxide) according to the list of active substances and suppliers, of 14 Feb. 2020, published by the European Chemicals Agency (ECHA), which is responsible for the publication of the relevant substances under Article 95 of the Biocidal Products Regulation (BPR), amended by EU Directive (EU) No. 334/2014 of 11 Mar. 2014.

The further essential component of the paint system of the invention is an anti-fouling metal and/or oxide thereof. What is meant by “anti-fouling” is that this metal and/or oxide is capable of retarding, containing or preventing surface colonization by animals, including microorganisms, and plants on objects to which the particles have been applied by coating, particularly for objects which are in contact with water, more particularly seawater.

The anti-fouling metal is preferably selected from the group consisting of copper, manganese, silver, tungsten, vanadium and tin, and oxides thereof. It is also possible that the paint system comprises two or more of these anti-fouling metals and/or oxides. The best results are displayed by a paint system wherein the main constituent of the anti-fouling metal is copper or copper(I) oxide.

The anti-fouling metal and/or oxide is preferably in spherical and/or spheroidal form and has an average particle diameter of 1 to 20 μm. However, it is also possible to use other forms, for example acicular structures.

The best results are obtained when the diameter, or in the case of acicular structures the longest side, of the anti-fouling metal and/or oxide is greater than the mean aggregate diameter of the fumed silica. More preferably, a ratio of the diameters is 10 to 1000.

The proportion of anti-fouling metal and/or oxide may be varied across broad limits. The paint system preferably includes 0.5% to 60% by weight, preferably 1% to 40% by weight, more preferably 5% to 30% by weight, of anti-fouling metal and/or oxide.

The proportion of fumed silica in the paint system may also be varied across broad limits.

However, it has been found that the paint system displays the best anti-fouling properties when the proportion of fumed silica is at least 0.5% to 30% by weight, preferably 1% to 20% by weight, more preferably 2% to 15% by weight, based on the paint system. Such high proportions cannot be achieved with standard fumed silica as obtained from the flame process because of the strong thickening effect thereof.

SEM images of a model paint system comprising Cu₂O particles and a fumed ground silica show that the surface of the Cu₂O particles is densely covered by fine fumed silica. These are not core-shell structures as described in the prior art, in which the shell is bonded to the core in a fixed manner. In the present case, electrostatic interactions if anything are assumed to be involved.

Preferably, the paint system according to the invention includes at least one co-biocide.

It is possible to use any approved biocides; customary co-biocides are selected from bis(1-hydroxy-1H-pyridin-2-thionato-O,S)copper (copper pyrithione), 4,5-dichloro-2-octylisothiazol-3(2H)-one (DCOIT), dichloro-N-[(dimethylamino)sulfonyl]fluoro-N-(p-tolyl)methanesulfenamide (tolylfluanid), copper thiocyanate, copper flakes (coated with a film of aliphatic acid), 4-bromo-2-(4-chlorophenyl)-5-(trifluoromethyl)-1H-pyrrole-3-carbonitrile (tralopyril), medetomidine, N-(dichlorofluormethyfthio)-N′,N′-dimethyl-N-phenylsulfamide (dichlofluanid), zinc pyrithione, zinc ethylenebis(dithiocarbamate) (polymeric) (zineb).

It is likewise conceivable that approved compounds are selected from alpha,alpha′,alpha″-trimethyl-1,3,5-triazine-1,3,5(2H,4H,6H)-triethanol (HPT), 1,2-benzisothiazol-3(2H)-one (BIT), 2,2-dibromo-2-cyanoacetamide (DBNPA), 2-phenoxyethanol, 2-propenoic acid, 2-methylbutyl ester polymer with butyl 2-propenoate and methyl 2-methyl-2-propenoate (CAS no: 25322-99-0)/polymeric quaternary ammonium bromide (PQ polymer), 3,3′-methylenebis[5-methyloxazolidine] (oxazolidine/MBO), 5-chloro-2-(4-chlorophenoxy)phenol (DCPP), 6-(phthalimido)peroxyhexanoic acid (PAP), alkyldimethylbenzylammonium chloride, Ampholyt 20, biphenyl-2-ol, bromochloro-5,5-dimethylimidazolidine-2,4-dione (BCDMH/bromochlorodimethylhydantoin), bronopol, chlorocresol, cinnamaldehyde/3-phenylpropen-2-al, citric acid, chlorophen, copper sulfate pentahydrate, D-gluconic acid compound with N,N″-bis(4-chlorophenyl)-3,12-diimino-2,4,11,13-tetraazatetradecanediamidine (2:1) (CHDG), didecyldimethylammonium chloride, dimethyloctadecyl[3-(trimethoxysilyl)propy]ammonium chloride, monolinuron, diuron, N-(3-aminopropyl)-N-dodecylpropane-1,3-diamine (diamine), poly(oxy-1,2-ethanediyl), alpha-[2-(didecylmethylammonio)ethyl]-omega-hydroxypropanoate salt (Bardap 26), PHMB (1600;1.8), pyridine-2-thiol 1-oxid sodium salt, sodium pyrithione, quarternary ammonium compounds, benzyl-C12-18-alkyldimethyl salts with 1,2-benzisothiazol-3(2H)-one 1,1-dioxide (1:1) (ADBAS), silver nitrate, silver phosphate glass, silver zinc zeolite, sodium dichlorisocyanurate dihydrate, sodium N-chlorobenzenesulfonamide (chloramine-B), symclosene, tosylchloramide sodium (chloramine T), troclosene sodium are used as co-biocide.

A conventional effective anti-fouling coating has, for example, a ratio of the copper oxide:zinc oxide:co-biocide components of about 3:1:1 by dry volume.

The paint system of the invention can be used to produce coatings that preferably have a ratio of the metal and/or oxide thereof:water-binding filler:co-biocide components of about 1:1:1 by dry volume.

In spite of a reduction in the amount of the anti-fouling metal and/or oxide thereof used, it has been found that, unexpectedly, the coatings according to the invention have the same or better anti-fouling properties than conventional coatings.

In general, the paint system according to the invention also comprises film-forming resins. Suitable polymers for this purpose are, for example, acrylates, methacrylates, silicone resins, polyesters, polyurethanes, and resins based on natural products. Preferably, the paint system comprises swellable or water-soluble resins, in order to facilitate release of the anti-fouling metal oxides. Swellable or water-soluble resins may be silyl acrylates or silyl methacrylates, such as tributylsilyl acrylate, triphenylsilyl acrylate, phenyldimethylsilyl acrylate, diphenylmethylsilyl acrylate, trimethylsilyl acrylate, triisopropylsilyl acrylate, or the corresponding methacrylates or metal acrylates. Rosin-based resins may also be part of the paint system according to the invention.

The invention further provides a substrate coated with the paint system. Suitable substrates include in principle all substrates, examples being those made of metal, plastic or glass fibre. The coating may be applied by means of known methods.

Application of the coating system according to the invention may generally take place by spray application, but may also preferably be applied by other application techniques, for example brushing, rolling, flow coating, dipping, pouring. Suitable substrates include metallic substrates such as, for example, steel, cast steel, stainless steel, aluminium, cast aluminium or hot dip galvanized steel. For improved adhesion, the substrate may be roughened by sandblasting or sanding. Nonmetallic substrates such as glass, plastics, or inorganic substrates such as ceramics, stoneware, concrete etc., may also be employed.

Preferably, the coated substrate has a theoretical release rate of the anti-fouling metal and/or metal oxide of at least 10 μg/cm²/day to at most 30 μg/cm²/day, measured to ASTM D 6442.

The present invention further provides for the use of the paint system for the coating of the aquatic region of a watersports boat, a commercial ship, or a built structure immersed in water, such as jetties, quay walls, oil drilling platforms, shipping channel markings or measurement probes.

The present invention allows the production of a paint system comprising an anti-fouling component and a specific fumed silica having high tamped density and low thickening. For the production, the components are stirred into the paint matrix with low energy input, for example by means of a dissolver. High energy inputs as described in the prior art are unnecessary.

Preferably, the anti-fouling metals and/or oxides thereof and fumed silica having a BET surface area of 150 to 400 m²/g, determined to DIN ISO 99277, having a tamped density of 100 to 300 g/l, determined to DIN EN ISO 787/11, and having a thickening of less than 500 mPas at 25° C., measured as disclosed in the description, are stirred into a paint matrix to form electrostatic interactions between the anti-fouling metal oxide particles and the fumed silica.

In addition, preferably, the stirring into the paint matrix is preceded by grinding of the fumed silica with a specific energy input of 200 to 2000 kJ/kg, preferably 500 to 1800 kJ/kg, most preferably 700 to 1500 kJ/kg, calculated by

specific energy input=(P_{D}−P_{D,0})×t/m

with P_{D}=total power input,
P_{D,0}=no-load power,
t=energy input time,
m=mass of silica used.

Preferably, the stirring-in of the silica and metals and/or oxides thereof is performed at a shear rate of 1000 rpm to 5500 rpm, preferably 3500-4000 rpm, for 5-180 minutes, preferably 15-60 minutes, more preferably 30-45 minutes, at a temperature up to 60° C. with or without glass beads.

Any temperature rise during the dispersion of more than 60° C. should be attenuated by suitable measures known to the person skilled in the art. A suitable example for this purpose is a jacketed grinding vessel with water cooling.

It may be appropriate that, depending on the specific composition, the temperature rise can also be attenuated at a temperature below 60° C.

The process according to the invention is preferably conducted without glass beads. This is because material losses of up to 50% occur in the case of incorporation with grinding media, for example glass beads, zirconia beads, since the component sticks to the grinding media. Typically, the glass beads are discarded after use. By contrast, the costly cerium-stabilized zirconia beads are recovered by complex cleaning by means of large amounts of solvent.

Preferably, in industrial production, in a horizontal bead mill or immersion mill, for example, especially when large amounts of silica are used, glass beads are used as grinding media for the process according to the invention. It is thus possible to assure high surface quality and additionally save costs, which is not the case when costly cerium-stabilized zirconia beads are used.

A further invention is the use of the above-described fumed silica for production of a paint system, in which the percentage by weight of the silica≤the percentage by weight of the metal and/or oxide thereof, based on the total weight of the paint system.

The examples which follow are provided merely to elucidate this invention to those skilled in the art and do not constitute any limitation of the claimed subject matter or of the claimed process whatsoever.

### Methods

### General Conditions

Where values are expressed in % in the context of the present invention, these are % by weight values unless otherwise stated. In the case of compositions, values in % are based on the entire composition unless otherwise stated. Where averages are reported hereinafter, these are number averages unless stated otherwise. Where measured values are reported hereinbelow, these measurements, unless stated otherwise, were determined at a pressure of 101325 Pa, a temperature of 23° C. and the ambient relative humidity of approx. 40%.

### General Production

The formulations were produced by means of a Dispermat CN-40F2 from VMA Getzmann. The paints were produced in a jacketed 1 l steel grinding vessel from Getzmann.

The following three methods were conducted:

### 1) With Glass Beads

A Teflon disc of diameter 50 mm was utilized. After the film-forming resins and solvents had been weighed out, glass beads of diameter 2.4-2.9 mm were added. Subsequently, the silica and the pigments and fillers were weighed in and dispersed at a rotation speed of 2500 rpm for 15 minutes. The metal and/or metal oxide was added and dispersed at 2000 rpm for a further 5 minutes. The residual constituents of the formulations were added at 1500 rpm, and the mixture was stirred for a further 5 minutes.

### 2) Without Glass Beads

A toothed disc of diameter 50 mm was used. After the film-forming resins and solvents had been initially charged, the silica and the pigments and fillers were added while stirring and dispersed at a shear rate of 3500 rpm for 30 minutes. Subsequently, the metal and/or metal oxide was added at a shear rate of 500 rpm, and dispersion was again effected at 2000 rpm for 20 minutes. Subsequently, the residual constituents of the formulations were added while gently stirring at 400 rpm.

### 3) With Zirconia Beads

A triple grinding disc of diameter 50 mm was used. After the film-forming resins and solvents had been weighed out, cerium-stabilized zirconia beads of diameter 2-3 mm were added. Subsequently, the silica was weighed in and dispersed at a rotation speed of 2000 rpm for 15 minutes. The metal and/or metal oxide and the further fillers and pigments were added and dispersed at 2000 rpm for a further 5 minutes. The residual constituents were added at 1500 rpm, and the mixture was stirred for a further 5 minutes.

The comparative formulations were produced correspondingly, but with variations here in the constituents and/or the amount used.

The formulations can be found in the respective tables.

In the context of this invention, the terms “paint system”, “system”, “formulation”, “composition”, “recipe”, “paint” are regarded as synonyms.

In the context of this invention, the terms “film”, “coating”, “paint film”, “paint surface” are regarded as synonyms.

### Application

The paint systems according to the invention and comparative paint systems applied to the substrate form films in a physical manner at room temperature. The appearance of the coating was assessed. The surface should form a continuous, homogeneous film. Any paint defects, such as craters, pinholes, edge thinning or the like, should be listed. Surface quality is likewise assessed visually. This is done by assessing the roughness of the paint film.

Drying Time Measurements Drying time was performed using a BK3 Drying Recorder (The Mickle Laboratory Engineering Co. Ltd., Goose Green, Gomshall, Guildford, Surrey GUS 9LJ, UK) according to ASTM D5895.

### Pendulum Hardness

A suitable procedure for assessment of the hardness of the inventive coatings and the comparative coatings is the pendulum damping test according to Konig or Persoz and defined in DIN EN ISO 1522. The hardnesses were measured according to this test method by means of a pendulum hardness instrument (model 299/300, Erichsen GmbH & Co. KG).

### Martens Hardness

Indentation hardness (Martens hardness) was determined using a Fischerscope HM2000 from Helmut Fischer GmbH. Martens hardness was determined to ISO 14577.

### Brittleness

Brittleness was determined by conducting measurements to DIN EN ISO 1520 by means of the Erichsen 202 EM lacquer and paint testing machine. What is reported is the Erichsen cupping in mm.

### Viscosity and Storage

The reported viscosities of the paint systems were determined with an Anton Paar MC103 rotary viscometer with the PP60 measurement geometry at 23° C. Several measurement points were recorded between the shear rates of 0.1 and 10001/s.

Storability was determined by storing the paint formulations in a drying oven at 50° C. for four weeks. Storage stability was assessed from the differences in viscosity.

### Determination of Anti-Fouling Character

The coatings produced with the paint system according to the invention were transported to static exposure experiments in the North Sea (Hooksiel or Nordemey).

The coated PVC panels were exposed over a season from March to October (8 months) at a depth of 20 cm below the water surface. Every 4 weeks, the test panels were subjected to visual examination and assessed with regard to overgrowth.

TABLE 1
Raw materials used

| Raw material | Brand name | Manufacturer |
|---|---|---|
| Iron oxide red | BAYFERROX ® 130 M | LANXESS |
| Copper oxide | Nordox Paint Grade Red | NORDOX |
| | copper(I) oxide | |
| Zinc oxide | Red Seal zinc oxide | EverZinc |
| Plasticizer | VESTINOL ® 9 | Evonik Performance |
| | | Materials GmbH |
| Polyamide wax | DISPARLON ® 6900- | King Industries |
| | 20X | |
| Rosin solution, 65% in | Procol ST | MEGARA RESINS ® |
| xylene | | |
| Acrylate solution, 40% | Paraloid ™B-66 40% ig | Dow Chemical |
| in xylene | | |
| Dispersant | TEGO ® Dispers 628 | Evonik Resource |
| | | Efficiency GmbH |
| Structure-modified | VP 4200 (SMS 1), | Evonik Resource |
| silica | AEROSIL ® R 9200 | Efficiency GmbH |
| | (SMS 2) | |
| Titanium dioxide | KRONOS ® 2310 | Kronos International |
| Gypsum | Terra Alba | ACG Materials |
| Aromatic hydrocarbon | SOLVESSO ™ 150 | Brenntag |
| Copper pyrithione | Copper Omadine ® | Lonza Ltd |
| | Powder AF | |
| Solvent | Butyl acetate | various |
| Solvent | Methoxypropyl acetate | various |
| Silyl acrylate | — | Prepared according to |
| solution, | | WO 2005/005516, |
| 35% in xylene | | Example 3a |
| Copper acrylate | — | Prepared according to |
| solution, | | EP 0779304, Example |
| 35% in xylene | | 1 |

Production of Paint Systems with Rosin

The formulations were produced by general production method 2) without glass beads. The raw materials can be found in Table 1. Table 2 (inventive) and Table 3 (comparative examples) show the amounts of the raw materials used.

Inventive paint systems Ka-Ke and comparative paint systems VK1-VK4 were produced.

The dry volume ratio (dryV %) of copper oxide:zinc oxide:co-biocide of Ka-Ke was about 1:1:1, and the weight ratio of silica:copper oxide was 1:5, 1:2, 3:5, 4:5 or 1:1. The amount of copper oxide is accordingly equal to or greater than the amount of silica.

VK1 is a standard paint system in which the dry volume ratio of copper oxide:zinc oxide:co-biocide was about 3:1:1 and no silica was used.

In the case of VK2, the dry volume ratio of copper oxide:zinc oxide:co-biocide was about 1:1:1, using no silica.

VK3 is a paint system with a weight ratio of 10 g of silica:5 g of copper oxide analogously to EP 3271426, with addition of zinc oxide.

VK4 is a paint system according to EP 3271426.

TABLE 2

| | Ka | | | Kb | | | Kc | | | Kd | | | | | |
|---|---|---|---|---|---|---|---|---|---|---|---|---|---|---|---|
| Raw material | [g] | dryV % | Ratio | [g] | dryV % | Ratio | [g] | dryV % | Ratio | [g] | dryV % | Ratio | Ke[g] | dryV % | Ratio |
| Procol ST | 21 | 37.4 | | 21 | 35.3 | | 21 | 35.3 | | 21 | 34.3 | | 21 | 33.4 | |
| VESTINOL ® 9 | 6 | 18.6 | | 6 | 17.6 | | 6 | 17.6 | | 6 | 17.1 | | 6 | 16.6 | |
| Paraloid^{TM}B-66 | 15 | 16.4 | | 15 | 15.5 | | 15 | 15.5 | | 15 | 15.1 | | 15 | 14.7 | |
| 40% ig | | | | | | | | | | | | | | | |
| TEGO ® Dispers | 2 | 3.1 | | 2 | 2.9 | | 2 | 2.9 | | 2 | 2.8 | | 2 | 2.7 | |
| 628 | | | | | | | | | | | | | | | |
| SMS 1 | 2 | 3 | 0.56 | 5 | 8.5 | 1.68 | 6 | 8.5 | 1.68 | 8 | 11.0 | 2.24 | 10 | 13.4 | 2.8 |
| SOLVESSO ™ | 12 | 0 | | 12 | 0 | | 12 | 0 | | 12 | 0 | | 12 | 0 | |
| 150 | | | | | | | | | | | | | | | |
| Xylene | 13 | 0 | | 10 | 0 | | 9 | 0 | | 7 | 0 | | 5 | 0 | |
| Copper pyrithione | 4 | 6 | 1.12 | 4 | 5.7 | 1.12 | 4 | 5.7 | 1.12 | 4 | 5.5 | 1.12 | 4 | 5.4 | 1.12 |
| KRONOS ® 2310 | 3 | 2.2 | | 3 | 2.1 | | 3 | 2.1 | | 3 | 2.0 | | 3 | 2.0 | |
| Gypsum | 2 | 2.7 | | 2 | 2.6 | | 2 | 2.6 | | 2 | 2.5 | | 2 | 2.4 | |
| Zinc oxide | 10 | 5.4 | 1 | 10 | 5.1 | 1 | 10 | 5.1 | 1 | 10 | 4.9 | 1 | 10 | 4.8 | 1 |
| Copper oxide | 10 | 5.1 | 0.95 | 10 | 4.8 | 0.95 | 10 | 4.8 | 0.95 | 10 | 4.7 | 0.95 | 10 | 4.6 | 0.95 |
| Total | 100 | 100 | | 100 | 100 | | 100 | 100 | | 100 | 100 | | 100 | 100 | |

TABLE 3

| | VK1 | | | VK2 | | | VK3 | | | VK4 | | |
|---|---|---|---|---|---|---|---|---|---|---|---|---|
| Raw material | [g] | dryV % | Ratio | [g] | dryV % | Ratio | [g] | dryV % | Ratio | [g] | dryV % | Ratio |
| Procol ST | 18 | 36.1 | | 18 | 41.3 | | 21 | 33.2 | | 23 | 35.1 | |
| VESTINOL ® 9 | 2 | 7.6 | | 2 | 8.7 | | 6 | 18.1 | | 7 | 18.6 | |
| Paraloid ™B-66 | 9 | 10.3 | | 9 | 11.7 | | 15 | 13.5 | | 17 | 16.0 | |
| 40% | | | | | | | | | | | | |
| TEGO ® Diapers | 2 | 3.4 | | 2 | 3.9 | | 2 | 2.7 | | 2 | 2.6 | |
| 628 | | | | | | | | | | | | |
| SMS 1 | 0 | 0.0 | | 0 | 0.0 | | 10 | 14.6 | 2.80 | 10 | 12.9 | |
| SOLVESSO ™ 150 | 10 | 0.0 | | 19 | 0.0 | | 12 | 0.0 | | 12 | 0.0 | |
| Xylene | 7 | 0.0 | | 18 | 0.0 | | 10 | 0.0 | | 10 | 0.0 | |
| Copper pyrithione | 4 | 7.4 | 1.12 | 4 | 8.5 | 1.12 | 4 | 5.8 | 1.12 | 4 | 5.2 | 1 |
| KRONOS ® 2310 | 4 | 3.0 | | 4 | 3.4 | | 3 | 1.8 | | 8 | 5.0 | |
| Gypsum | 4 | 6.7 | | 4 | 7.7 | | 2 | 2.7 | | 2 | 2.3 | |
| Zinc oxide | 10 | 6.6 | 1 | 10 | 7.6 | 1 | 10 | 5.2 | 1 | 0 | 0.0 | 0 |
| Copper oxide | 30 | 18.8 | 2.85 | 10 | 7.2 | 0.95 | 5 | 2.5 | 0.47 | 5 | 2.2 | 0.43 |
| Total | 100 | 100 | | 100 | 100 | | 100 | 100 | | 100 | 100 | |

### 1.1 Testing of Storage Stability

### 1.1.1 Measurement of Viscosities

TABLE 4

| | Description | | |
|---|---|---|---|
| | | Kc | VK1 |
| | | Before storage, after 24 h | |
| | | | Minor flotation |
| | | Homogeneous | of solvents |
| | | After storage at 50° C. for 4 weeks | |
| | | No flotation of | Significant |
| | | solvents, slight | sediment, difficult |
| | | sediment, can | to stir up, |
| | | readily be | significant flota- |
| | | stirred up | tion of solvents |
| Shear rate 0.1 [1/s] | Before storage | 11652 | 34169 |
| Shear rate 100 [1/s] | | 1355.1 | 430 |
| Shear rate 0.1 [1/s] | After storage at | 13174 | 83203 |
| Shear rate 100 [1/s] | 50° C. for 4 | 1792 | 916.27 |
| | weeks | | |

It has been found that the inventive paint system Kc has better storage stability than the conventional system VK1 without silica. The differences in viscosity between measurements before and after storage are significantly less in the Kc system than in the VK1 system.

After storage for 24 h and after 4 weeks, it was not possible to detect any flotation of solvents and only a slight sediment of solids in Kc, which could be readily stirred up again.

If there is significant change in the viscosity of the paint during storage, it becomes difficult to process, for example by spray application. Good and reliable paint formulations have a stable viscosity profile as possessed by the paints according to the invention.

### 1.2 Testing of Anti-Fouling and Paint Properties

For the further tests, the paint systems produced were applied with a 300 μm spiral applicator to the cleaned substrate required for the respective test method.

### 1.2.1 Visual Assessment and Drying Time Measurement

Ka-Ke, VK2-VK5 were applied to aluminium. Homogeneous, continuous paint films were formed, which dried through within 0.5 h. The dried paint surfaces did not show any defects.

### 1.2.2 Measurement of Martens Hardness

Kc, VK2-VK5 were applied to glass plates. Martens hardness was measured after a drying time of 7 days.

TABLE 5

| | Martens hardness |
|---|---|
| Kc | 255 |
| VK2 | 225 |
| VK3 | 173 |
| VK4 | 228 |
| VK5 | 219 |

The coating according to the invention has higher Martens hardness. It is thus more stable to impacts and abrasion.

### 1.2.3 Determination of Anti-Fouling Character

Formulations Ka-Ke and VK2-VK5 were applied to PVC plates and exposed to seawater in the German North Sea from March 2018 to October 2019.

The overall assessment was effected by means of a scale as shown below of

0=no overgrowth
1=minimal overgrowth, very easy to remove
252=slight overgrowth, very easy to remove
3=moderate overgrowth, distinct residues
4=severe overgrowth, significant residues
5=very severe overgrowth, not removable.

TABLE 6

| | Assessment |
|---|---|
| Ka | 1 |
| Kb | 0 |
| Kc | 0 |
| Kd | 0 |
| Ke | 0 |
| VK2 | 0 |
| VK3 | 5 |
| VK4 | 3 |
| VK5 | 3 |

The good results in the seawater exposure show that the addition of silica can increase the efficiency of the paint systems according to the invention. The amount of copper oxide used can be distinctly lowered.

VK5 and even VK4 show a weaker anti-fouling effect.

### 1.4 Measurement of Brittleness

Brittleness was assessed by applying the formulations listed in Table 7 to aluminium sheets.

TABLE 7

| Formulation | Cupping [mm] |
|---|---|
| Ka | 9.4 |
| Kb | 6.7 |
| Kc | 3.1 |
| Kd | 2.8 |
| VK4 | 1.3 |
| VK5 | 1.5 |

VK4 and VK5 show elevated brittleness. By contrast, the inventive coatings Ka-Kd are more flexible.

2. Production of Paint Systems with Silyl Acrylate The formulations were produced by general production method 2) without glass beads. The raw materials can be found in Table 1. The amounts of the inventive paint systems Ya and Yb and of comparative paint systems VY1 and VY2 used are listed in Table 8.

The dry volume ratio of copper oxide:zinc oxide:co-biocide of Ya-Yb was about 1:1:1, and the weight ratios of silica:copper oxide were 1:2 or 2:3. The amount of copper oxide is accordingly greater than the amount of silica.

VY1 is a standard paint system in which the dry volume ratio of copper oxide:zinc oxide:co-biocide was about 3:1:1 and no silica was used.

In the case of VY2, the dry volume ratio of copper oxide:zinc oxide:co-biocide was about 1:1:1, using no silica.

TABLE 8

| | Ya | | | Yb | | | VY1 | | | VY2 | | |
|---|---|---|---|---|---|---|---|---|---|---|---|---|
| | % by | dry | | % by | dry | | % by | dry | | % by | dry | |
| Raw materials | wt. | V % | Ratio | wt. | V % | Ratio | wt. | V % | Ratio | wt. | V % | Ratio |
| Silyl acrylate | 20 | 21.20 | | 20.75 | 22.22 | | 15.75 | 17.61 | | 15.75 | 20.70 | |
| solution, 35% in | | | | | | | | | | | | |
| xylene | | | | | | | | | | | | |
| PROCOL ST | 5 | 12.35 | | 5 | 12.47 | | 5 | 13.03 | | 5 | 15.31 | |
| 65% in xylene | | | | | | | | | | | | |
| Copper pyrithione | 3.15 | 6.58 | 0.7 | 3.15 | 6.65 | 1.0 | 3.15 | 6.95 | 1.0 | 3.15 | 8.16 | 0.7 |
| BAYFERROX ® | 4 | 3.34 | | 4 | 3.38 | | 4 | 3.53 | | 4 | 4.15 | |
| 130 M | | | | | | | | | | | | |
| KRONOS ® 2310 | 6 | 6.12 | | 6 | 6.18 | | 6 | 6.45 | | 6 | 7.59 | |
| SMS 1 | 7.1 | 14.84 | | 8 | 16.89 | | 0 | 0.00 | | 0 | 0.00 | |
| Cu₂O | 14.2 | 10.11 | 1.1 | 12 | 8.63 | 1.3 | 37 | 27.80 | 3.9 | 14.2 | 12.54 | 1.1 |
| Zinc oxide | 11.8 | 8.81 | 1.0 | 9 | 6.79 | 1.0 | 9 | 7.09 | 1.0 | 11.8 | 10.92 | 1.0 |
| VESTINOL ® 9 | 3.6 | 15.36 | | 3.6 | 15.51 | | 3.6 | 16.20 | | 3.6 | 19.04 | |
| DISPARLON ® | 1.5 | 1.28 | | 1.5 | 1.29 | | 1.5 | 1.35 | | 1.5 | 1.59 | |
| 6900-20X | | | | | | | | | | | | |
| Xylene | 23.65 | 0 | | 27 | 0 | | 15 | 0 | | 35 | 0.00 | |
| Total | 100 | 100.00 | | 100 | 100.00 | | 100 | 100.00 | | 100 | 100.00 | |

### 2.1 Testing of Anti-Fouling and Paint Properties

The paint systems produced were applied with a 300 μm spiral applicator to the cleaned substrate required for the respective test method.

### 2.1.1 Visual Assessment and Drying Time Measurement

Homogeneous, continuous paint films were formed, which dried through within 0.5 h. The dried paint surfaces did not show any defects.

### 2.1.2 Measurement of Pendulum Hardness

Pendulum hardness was measured by applying the formulations listed in Table 9 to aluminium sheets.

TABLE 9

| Formulation | König pendulum impacts |
|---|---|
| Ya | 63 |
| Yb | 47 |
| VY1 | 29 |
| VY2 | 23 |

The results show that the hardness of the coatings Ya and Yb produced with the paint systems of the invention is greater than that of the comparative examples. Thus, the coatings according to the invention have greater stability to impacts and abrasions.

### 2.1.3 Determination of Anti-Fouling Character

Formulations Ya and Yb and VY1 and VY2 were applied to PVC plates and exposed to seawater in the German North Sea from March 2018 to October 2019.

The overall assessment was effected by means of a scale as shown below of

0=no overgrowth
1=minimal overgrowth, very easy to remove
2=slight overgrowth, very easy to remove
103=moderate overgrowth, distinct residues
4=severe overgrowth, significant residues
5=very severe overgrowth, not removable.

TABLE 10

| Formulation | Result |
|---|---|
| Ya | 0 |
| Yb | 0 |
| VY1 | 0 |
| VY2 | 4 |

The coatings that were produced with the inventive systems Ya and Yb, with a ratio of about 1:1:1 of copper oxide:zinc oxide:co-biocide by dry volume, likewise show good results in seawater exposure, as with a VY1 system with a ratio of about 3:1:1 of copper oxide:zinc oxide:co-biocide by dry volume. The amount of copper oxide used can be distinctly lowered. If the copper oxide content is reduced without using silica, as in the case of VY2, significant overgrowth of the coating surface was detected within the test period.

3. Production of Paint Systems with Copper Acrylate

The formulations were produced by general production method 2) without glass beads. The raw materials can be found in Table 1. The amounts of the inventive paint systems Za and Zb and of comparative paint systems VZ1 and VZ2 used are listed in Table 11.

The dry volume ratio of copper oxide:zinc oxide:co-biocide of Za-Zb was about 1:1:1, and the weight ratios of silica:copper oxide were 1:2 with two different silicate types. The amount of copper oxide is accordingly greater than the amount of silica.

VZ1 is a standard paint system in which the dry volume ratio of copper oxide:zinc oxide:co-biocide was about 3:1:1 and no silica was used.

In the case of VZ2, the dry volume ratio of copper oxide:zinc oxide:co-biocide was about 1:1:1, using no silica.

TABLE 11

| | Za | | | Zb | | | VZ1 | | | VZ2 | | |
|---|---|---|---|---|---|---|---|---|---|---|---|---|
| | % by | DryV | | % by | DryV | | % by | DryV | | % by | DryV | |
| Raw materials | wt. | [%] | Ratio | wt. | [%] | Ratio | wt. | [%] | Ratio | wt. | [%] | Ratio |
| Copper acrylate | 41.1 | 40.00 | | 41.1 | 40.31 | | 40.85 | 41.01 | | 40.85 | 46.04 | |
| solution, 35% in | | | | | | | | | | | | |
| xylene | | | | | | | | | | | | |
| Copper pyrithione | 3.15 | 6.05 | 0.77 | 3.15 | 6.10 | 0.80 | 3.15 | 6.24 | 0.81 | 3.15 | 7 | 0.81 |
| BAYFERROX ® | 4 | 3.07 | | 4 | 3.10 | | 4 | 3.17 | | 4 | 3.56 | |
| 130 M | | | | | | | | | | | | |
| KRONOS ® 2310 | 6 | 5.62 | | 6 | 5.66 | | 6 | 5.80 | | 6 | 6.51 | |
| SMS 1 | 6.8 | 13.06 | | 0 | 0 | | 0 | 0 | | 0 | 0 | |
| SMS 2 | 0 | 0.00 | | 6.8 | 13.16 | | 0 | 0 | | 0 | 0 | |
| Cu₂O | 13.8 | 9.03 | 1.15 | 13.1 | 8.64 | 1.14 | 30 | 20.24 | 2.63 | 13.8 | 10.45 | 1.21 |
| Zinc oxide | 11.4 | 7.82 | 1 | 10.95 | 7.57 | 1 | 10.9 | 7.71 | 1 | 10.9 | 8.66 | 1 |
| VESTINOL ® 9 | 3.6 | 14.18 | | 3.6 | 14.29 | | 3.6 | 14.62 | | 3.6 | 16.42 | |
| DISPARLON ® | 1.5 | 1.18 | | 1.5 | 1.18 | | 1.5 | 1.21 | | 1.5 | 1.36 | |
| 6900-20X | | | | | | | | | | | | |
| Xylene | 8.65 | 0.00 | | 9.8 | 0 | | 0 | 0 | | 16.2 | 0 | |
| Total | 100 | 100 | | 100 | 100 | | 100 | 100 | | 100 | 100 | |

### 3.1 Testing of Anti-Fouling and Paint Properties

The paint systems produced were applied with a 300 μm spiral applicator to the cleaned substrate required for the respective test method.

### 3.1.1 Visual Assessment and Drying Time Measurement

After application, homogeneous, continuous paint films were formed, which dried through within 0.5 h. The dried paint surfaces did not show any defects.

### 3.1.2 Measurement of Pendulum Hardness

Pendulum hardness was measured by applying the formulations to aluminium sheets.

TABLE 12

| Formulation | König pendulum impacts |
|---|---|
| Za | 25 |
| Zb | 23 |
| VZ1 | 12 |
| VZ2 | 12 |

The coatings produced with the inventive paint systems Za and Zb show higher hardness than the comparative coatings. They thus have greater stability to impacts and abrasions.

### 3.1.3 Determination of Anti-Fouling Character

Formulations Za and Zb and VZ1 and VZ2 were applied to PVC plates and exposed to seawater in the German North Sea from March 2018 to October 2019.

The overall assessment was effected by means of a scale as shown below of

0=no overgrowth
1=minimal overgrowth, very easy to remove
2=slight overgrowth, very easy to remove
3=moderate overgrowth, distinct residues
4=severe overgrowth, significant residues
5=very severe overgrowth, not removable.

TABLE 13

| Formulation | Result |
|---|---|
| Za | 0 |
| Zb | 0 |
| VZ1 | 0 |
| VZ2 | 4 |

The coatings that were produced with the inventive systems Za and Zb, with a ratio of about 1:1:1 of copper oxide:zinc oxide:co-biocide by dry volume, likewise show good results in seawater exposure, as with a VZ1 system with a ratio of about 3:1:1 of copper oxide:zinc oxide:co-biocide by dry volume. The amount of copper oxide used can be distinctly lowered.

If the copper oxide content is reduced without using silica, as in the case of VZ2, significant overgrowth of the coating surface was detected within the test period.

4.

Process According to the Invention

Formulations Za and Zb from Table 11 were produced by the production methods described above. Production methods 1) and 2) are inventive; production method 3) is according to EP 3271426.

The yield of the systems produced was used to determine the loss of material. For visual determination of surface quality, the systems produced were applied to aluminium.

The results are listed in Table 14.

TABLE 14

| | | | Anti-fouling |
|---|---|---|---|
| | Yield [%] | Surface quality | character |
| Za | | | |
| 1) with glass beads | 67 | very smooth | 0 |
| 2) without glass beads | 90 | rough | 0 |
| 3) with zirconia beads | 65 | very smooth | 0 |
| Zb | | | |
| 1) with glass beads | 69 | very smooth | 0 |
| 2) without glass beads | 93 | rough | 0 |
| 3) with zirconia beads | 66 | very smooth | 0 |

If glass beads or zirconia beads are used as grinding media, it is possible to achieve better surface quality. However, there are significant yield losses of nearly 20%. There are thus two options available to the user. If the user should choose a high yield because surface quality is immaterial for particular applications, the process according to the invention without glass beads is recommended. If surface quality is important, the process according to the invention with glass beads is recommended. The user can obtain a somewhat higher yield compared to a method with zirconia beads having equal surface quality and anti-fouling action. The small higher yield may then assume an economically important role, for example, in the industrial scale production of the systems. The use of glass beads additionally has further advantages since these are significantly less expensive and easier to use. Furthermore, it is possible to reduce environmental pollution resulting from the cleaning of the zirconia beads with large amounts of solvents.

1. A paint system, comprising:
at least one anti-fouling metal and/or oxide thereof and a fumed silica,
wherein the fumed silica has a BET surface area of 150 to 400 m²/g, determined to DIN ISO 99277,
a tamped density of 100 to 300 g/l, determined to DIN EN ISO 787/11, and
a thickening of less than 500 mPas at 25° C.,
obtainable after grinding with a specific energy input of 200 to 2000 kJ/kg,
calculated according to
specific energy input=(P_{D}−P_{D,0})×t/m
with P_{D}=total power input,
P_{D,0}=no-load power,
t=energy input time, and
m=mass of silica introduced,
wherein a percentage by weight of silica≤a percentage by weight of the at least one anti-fouling metal and/or oxide thereof, based on the total weight of the paint system, and
wherein the paint system includes at least one water-binding organic and/or inorganic filler.

2. The paint system according to claim 1, wherein the percentage by weight of silica relative to the percentage by weight of the at least one anti-fouling metal and/or oxide thereof is from 1:1 to 1:10, based on the total weight of the paint system.

3. The paint system according to claim 1, wherein the at least one water-binding organic and/or inorganic filler is selected from the group consisting of zinc oxide, gypsum, barium sulfate, a sheet silicate, a carbonate and titanium dioxide.

4. The paint system according to claim 1, wherein the at least one anti-fouling metal and/or oxide thereof is selected from the group consisting of copper, manganese, silver, tungsten, vanadium, tin, and oxides thereof.

5. The paint system according to claim 1, wherein a proportion of anti-fouling metal and/or oxide thereof is 0.5% to 60% by weight, based on the total weight of the paint system.

6. The paint system according to claim 1, wherein a proportion of fumed silica is 0.5% to 30% by weight, based on the total weight of the paint system.

7. The paint system according to claim 1, wherein the fumed silica is a hydrophilic or hydrophobic silica.

8. The paint system according to claim 1, wherein the paint system comprises film-forming resins.

9. A substrate, coated with the paint system according to claim 1.

10. The substrate according to claim 9, wherein the substrate has a theoretical release rate of at least 10 μg/cm²/day to at most 30 μg/cm²/day, measured to ASTM D 6442.

11. A process for producing the paint system according to claim 1, wherein the at least one anti-fouling metal and/or oxide thereof and the fumed silica having a BET surface area of 150 to 400 m²/g, determined to DIN ISO 99277, having a tamped density of 100 to 300 g/l, determined to DIN EN ISO 787/11, and having a thickening of less than 500 mPas at 25° C., are stirred into a paint matrix to form electrostatic interactions between anti-fouling metal oxide particles and the fumed silica.

12. The process according to claim 11, wherein the stirring into the paint matrix is preceded by grinding of the fumed silica with a specific energy input of 200 to 2000 kJ/kg, calculated by
specific energy input=(P_{D}−P_{D,0})×t/m
with P_{D}=total power input,
P_{D,0}=no-load power,
t=energy input time, and
m=mass of silica used.

13. The process according to claim 11, wherein the stirring-in of the silica and the at least one metal and/or oxide thereof is performed at a shear rate of 1000 rpm to 5500 rpm, for 5-180 minutes, up to a temperature of 60° C., with or without glass beads.

14. A method of coating an aquatic region of a watersports boat, a commercial ship, or a built structure immersed in water, the method comprising:
applying the paint system according to claim 1 to said aquatic region.

15. The paint system according to claim 1, wherein the grinding is with a specific energy input of 700 to 1500 kJ/kg.

16. The paint system according to claim 2, wherein the percentage by weight of silica relative to the percentage by weight of the at least one anti-fouling metal and/or oxide thereof is from 1:1 to 1:5, based on the total weight of the paint system.

17. The paint system according to claim 3, wherein the at least one water-binding organic and/or inorganic filler is a sheet silicate selected from the group consisting of talc, kaolin, and mica; or
wherein the at least one water-binding organic and/or inorganic filler is a carbonate selected from the group consisting of chalk and calcite.

18. The paint system according to claim 5, wherein the proportion of anti-fouling metal and/or oxide thereof is 5% to 30% by weight, based on the total weight of the paint system.

19. The paint system according to claim 6, wherein the proportion of fumed silica is 2% to 15% by weight, based on the total weight of the paint system.

20. The process according to claim 13, wherein the stirring-in of the silica and the at least one metal and/or oxide thereof is performed for 30-45 minutes.
